(19) United States
(12) Patent Application Publication
(10) Pub. No.: US 2017/0244891 A1
(43) Pub. Date: Aug. 24, 2017

(54) METHOD FOR AUTOMATICALLY CAPTURING PHOTOGRAPH, ELECTRONIC DEVICE AND MEDIUM

(71) Applicant: Beijing Xiaomi Mobile Software Co., Ltd., Beijing (CN)

(72) Inventors: Lin LIU, Beijing (CN); Haipo ZHANG, Beijing (CN); Jingmin FENG, Beijing (CN)

(21) Appl. No.: 15/441,189

(22) Filed: Feb. 23, 2017

(30) Foreign Application Priority Data
Feb. 24, 2016 (CN) 201610101967.8

(51) Int. Cl. H04N 5/232; H04N 5/907

(52) U.S. Cl. CPC H04N 5/23219; H04N 5/23293; H04N 5/907

(57) ABSTRACT

A method for automatically capturing a photograph, an electronic device and medium are provided. The method includes: determining a facial feature in the photograph on a current display interface; calculating a facial appearance value corresponding to the facial feature, if it is determined to trigger an appearance value calculation; determining whether the facial appearance value is greater than a preset threshold corresponding to the facial feature; acquiring and storing the photograph on the display interface, if the facial appearance value is greater than the preset threshold.

### CROSS-REFERENCE TO RELATED APPLICATIONS

This application is based on and claims priority to Chinese Patent Application Serial No. 201610101967.8, filed with the State Intellectual Property Office of P.R. China on Feb. 24, 2016, the entire content of which is incorporated herein by reference.

### TECHNICAL FIELD

The present disclosure relates to a terminal technology field, and more particularly, to a method for automatically capturing a photograph, an electronic device and a medium.

### BACKGROUND

With the growing popularity of shooting photographs, it becomes a point of interest for a user to evaluate an appearance value when shooting photographs. A facial appearance value will be calculated by an appearance value evaluation algorithm after a face of the user is recognized, so as to ensure that the user may be shot at such an angle that a higher appearance value is obtained. Typically, the user finds such angle by trying at different angles when shooting photographs and then manually triggers a photograph-shooting operation, which however easily results in an angle change of the face of the user within a photograph-shooting range, thus missing a scene where a high appearance value may be obtained.

### SUMMARY

Embodiments of the present disclosure provide a method for automatically capturing a photograph, an electronic device and a medium.

According to a first aspect of embodiments of the present disclosure, there is provided a method for automatically capturing a photograph, and the method includes:determining a facial feature in the photograph on a current display interface; calculating a facial appearance value corresponding to the facial feature, if it is determined to trigger an appearance value calculation; determining whether the facial appearance value is greater than a preset threshold corresponding to the facial feature; and acquiring and storing the photograph on the display interface, if the facial appearance value is greater than the preset threshold.

According to a second aspect of embodiments of the present disclosure, there is provided an electronic device, and the electronic device includes: a processor; and a memory, configured to store an instruction executable by the processor; in which the processor is configured to: determine a facial feature in the photograph on a current display interface; calculate a facial appearance value corresponding to the facial feature, if it is determined to trigger an appearance value calculation; determine whether the facial appearance value is greater than a preset threshold corresponding to the facial feature; and acquire and store the photograph on the display interface, if the facial appearance value is greater than the preset threshold.

According to a third aspect of embodiments of the present disclosure, there is provided a non-transitory computer-readable storage medium having stored therein instructions that, when executed by a processor of an electronic device, cause the electronic device to perform the method for automatically capturing a photograph, and the method includes: determining a facial feature in the photograph on a current display interface; calculating a facial appearance value corresponding to the facial feature, if it is determined to trigger an appearance value calculation; determining whether the facial appearance value is greater than a preset threshold corresponding to the facial feature; and acquiring and storing the photograph on the display interface, if the facial appearance value is greater than the preset threshold.

It is to be understood that both the foregoing general description and the following detailed description are exemplary and explanatory only, and shall not be construed to limit the present disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1A is a flow chart showing a method for automatically capturing a photograph according to an example embodiment.

FIG. 1B is a schematic diagram showing a scene in which a method for automatically capturing a photograph is implemented according to an example embodiment.

FIG. 1C is a schematic diagram showing another scene in which a method for automatically capturing a photograph is implemented according to an example embodiment.

FIG. 2A is a flow chart showing determining whether to trigger an appearance value calculation according to some embodiments.

FIG. 2B is a flow chart showing determining whether to trigger an appearance value calculation according to some embodiments.

FIG. 3 is a flow chart showing a method for automatically capturing a photograph according to some embodiments.

FIG. 4 is a flow chart showing a method for automatically capturing a photograph according to some embodiments.

FIG. 5 is a flow chart showing how to determine a preset threshold according to some embodiments.

FIG. 6 is a flow chart showing a method for automatically capturing a photograph according to some embodiments.

FIG. 7 is a block diagram showing a device for automatically capturing a photograph according to an example embodiment.

FIG. 8 is a block diagram showing another device for automatically capturing a photograph according to an example embodiment.

FIG. 9 is a block diagram showing further another device for automatically capturing a photograph according to an example embodiment.

FIG. 10 is a block diagram showing yet another device for automatically capturing a photograph according to an example embodiment.

FIG. 11 is a block diagram showing a device suitable for automatically capturing a photograph according to an example embodiment.

### DETAILED DESCRIPTION

Example embodiments will be described in detail herein, and examples thereof are illustrated in accompanying drawings. The following description refers to the accompanying drawings in which the same numbers in different drawings represent the same or similar elements unless otherwise represented. The implementations set forth in the following description of example embodiments do not represent all implementations consistent with the invention. Instead, they are merely examples of apparatuses and methods consistent with aspects related to the invention as recited in the appended claims.

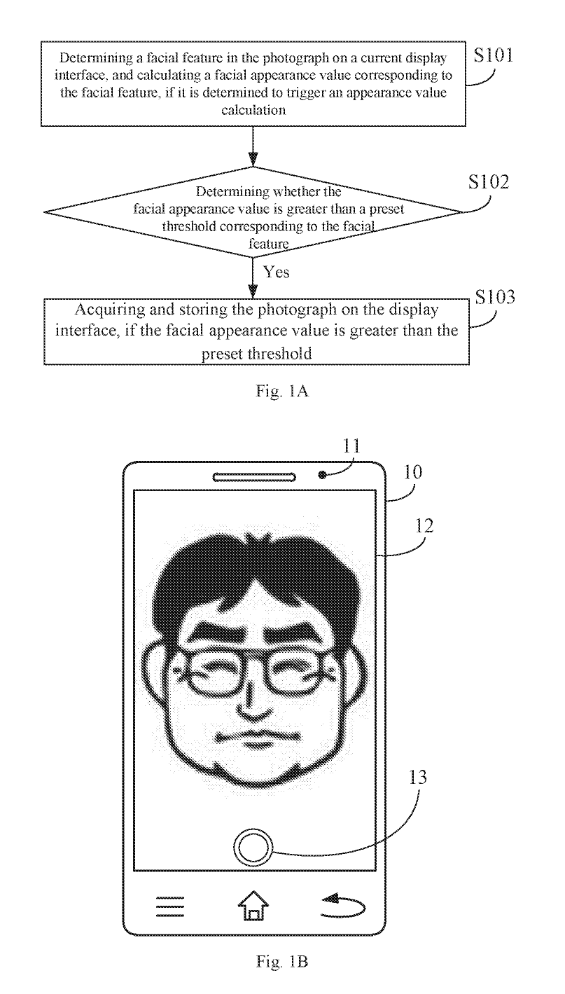

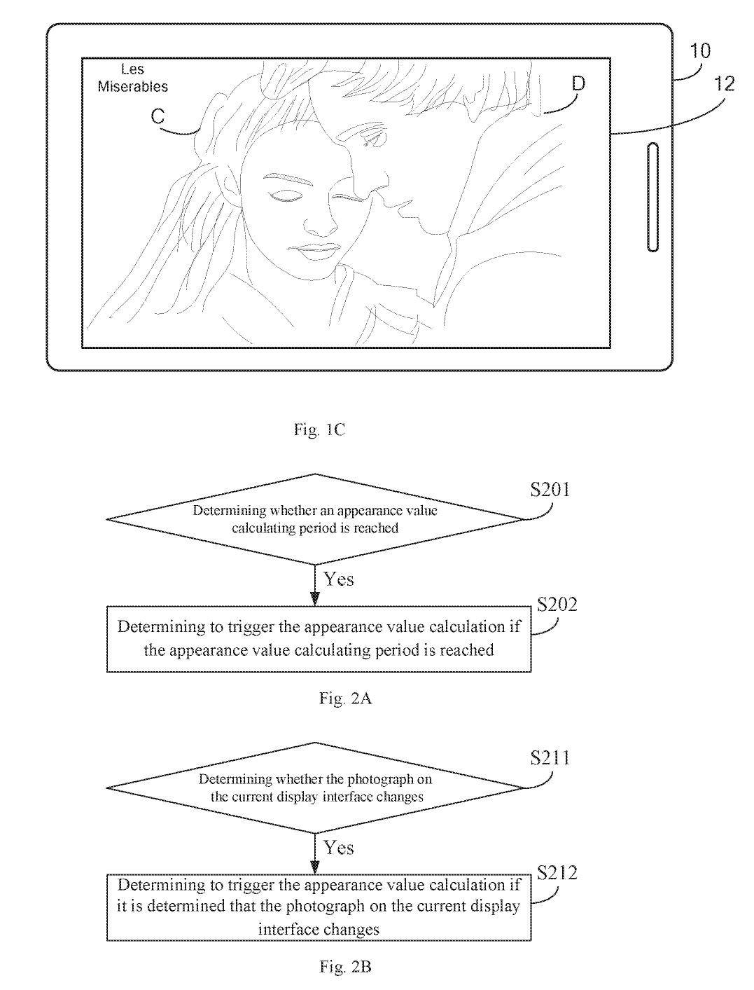

FIG. 1A is a flow chart showing a method for automatically capturing a photograph according to an example embodiment, FIG. 1B is a schematic diagram showing a scene in which a method for automatically capturing a photograph is implemented according to an example embodiment, and FIG. 1C is a schematic diagram showing another scene in which a method for automatically capturing a photograph is implemented according to an example embodiment. The method for automatically capturing a photograph may be applied in an electronic device (for example, smart phone, tablet computer etc.) and may be achieved by installing an application on the electronic device. As shown in FIG. 1A, the method for automatically capturing a photograph includes steps S101-S103 as follows.

In step S101, a facial feature in the photograph on a current display interface is determined and a facial appearance value corresponding to the facial feature is calculated, if it is determined to trigger an appearance value calculation.

In an embodiment, with respect to how to determine a condition for triggering an appearance value calculation, reference can be made to the following description of an embodiment shown in FIG. 2, which will not be elaborated here. In an embodiment, the facial feature in the photograph on the current display interface may be obtained by a face detection algorithm in the related art, and the facial appearance value corresponding to the facial feature may be calculated according to an appearance value algorithm in the related art, which will not be elaborated herein.

In step S102, it is determined whether the facial appearance value is greater than a preset threshold corresponding to the facial feature. If the facial appearance value is greater than the preset threshold, step S103 is executed, if the facial appearance value is lower than or equal to the preset threshold, step S101 is re-executed.

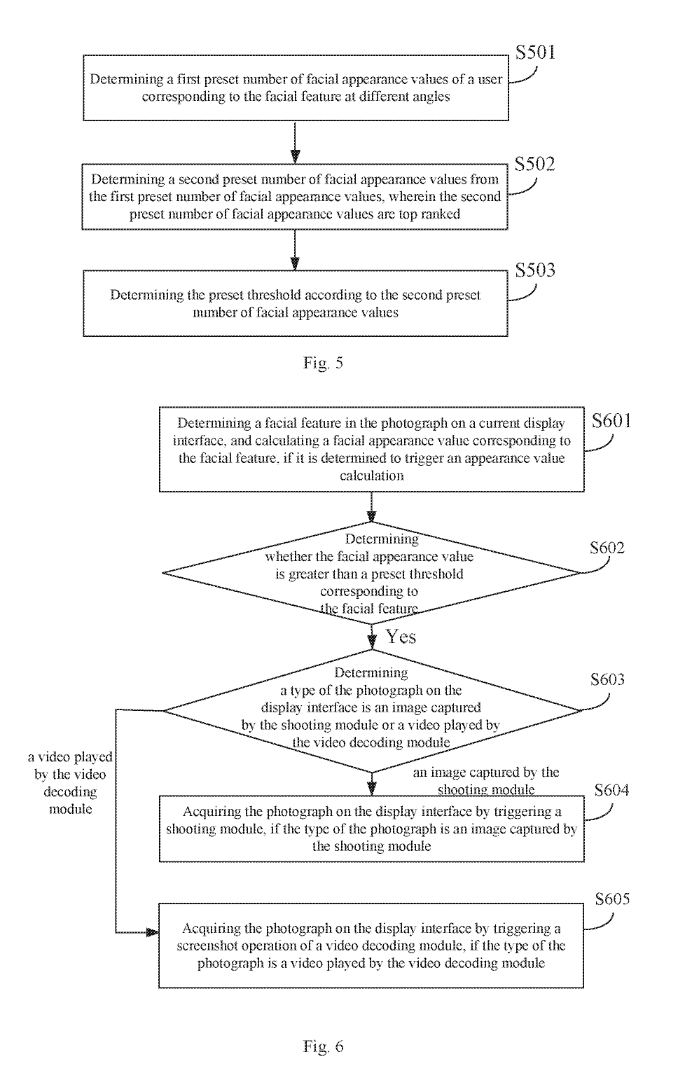

In an embodiment, with respect to a method for determining the preset threshold, reference can be made to the following description of an embodiment shown in FIG. 5, which will not be elaborated here.

In step S103, if the facial appearance value is greater than the preset threshold, the photograph on the display interface is acquired and stored.

As an example scene, as shown in FIG. 1B, when a user A needs to take a selfie with an electronic device 10, a front camera 11 of the electronic device 10 captures image information of the user at different shooting angles. If a facial feature of the user A in a photograph on a current display interface of the electronic device 10 is detected, a facial appearance value corresponding to the facial feature of the user A is calculated. If the facial appearance value of the user A is greater than a preset threshold corresponding to the user A, the photograph on the display interface 12 of the electronic device 10 is acquired and stored, which may ensure that a higher facial appearance value may be achieved in the shot photograph.

As another example scene, as shown in FIG. 1C, when a user B plays a video file (such as Les Miserables) with an electronic device 10, facial features of users C and D in a photograph on a current display interface of the electronic device 10 may be detected, and a facial appearance value corresponding to the facial feature of the user C and a facial appearance value corresponding to the facial feature of the user D are calculated. If both the facial appearance value of the user C and the facial appearance value of the user D are greater than a same preset threshold, or if the facial appearance value of the user C is greater than a preset threshold corresponding to the user C and the facial appearance value of the user D is greater than a preset threshold corresponding to the user D, the photograph on the display interface 12 of the electronic device 10 is acquired and stored, such that the photograph of users C and D with highest appearance values in the video file may be obtained.

In this embodiment, a photograph-shooting quality is quantized by the facial appearance value, which avoids a subjective evaluation of the user for obtaining a photograph with a higher appearance value from photographs shot at different shooting angles. If the facial appearance value is greater than the preset threshold, the photograph on the display interface is acquired and stored, which avoids a change of shooting angle due to a manual trigger of a shutter button and thus avoids missing a scene where a high appearance value may be obtained, thereby leaving more exciting moments for the user.

In an embodiment, the method further includes: determining whether an appearance value calculating period is reached according to a preset calculating frequency;determining to trigger the appearance value calculation if the appearance value calculating period is reached; or determining whether the photograph on the current display interface changes; determining to trigger the appearance value calculation if it is determined that the photograph on the current display interface changes.

In an embodiment, if there are a plurality of facial features in the photograph on the current display interface and the plurality of facial features correspond to a same preset threshold, determining whether the facial appearance value is greater than a preset threshold corresponding to the facial feature may include: determining whether each of facial appearance values corresponding to the plurality of facial features is greater than the same preset threshold; storing a pre-shot picture if the facial appearance value is greater than the preset threshold includes: shooting the photograph on the current display interface as a picture and storing the picture, if each of the facial appearance values corresponding to the plurality of facial features is greater than the same preset threshold.

In an embodiment, if there are a plurality of facial features in the photograph on the current display interface and each of the plurality of facial features corresponds to a respective preset threshold, determining whether the facial appearance value is greater than a preset threshold corresponding to the facial feature may include: determining for each facial feature whether the facial appearance value of the facial feature is greater than the preset threshold corresponding to the facial feature; storing a pre-shot picture if the facial appearance value is greater than the preset threshold includes: shooting the photograph on the current display interface as a picture and storing the picture, if the facial appearance value of each facial feature is greater than the preset threshold corresponding to the facial feature.

In an embodiment, the method may further include: determining a first preset number of facial appearance values of a user corresponding to the facial feature at different angles; determining a second preset number of facial appearance values from the first preset number of facial appearance values, in which the second preset number of facial appearance values are top ranked; determining the preset threshold according to the second preset number of facial appearance values.

In an embodiment, the method may further include: determining to trigger the preset threshold corresponding to the facial feature, if it is determined to activate an mode for determining a facial appearance threshold; or determining to trigger the preset threshold corresponding to the facial feature, if it is determined to activate a camera to start capturing a photograph; or searching whether the preset threshold corresponding to the facial feature is stored after a facial appearance value of the facial feature is calculated, and determining to trigger the preset threshold corresponding to the facial feature, if it is determined that the preset threshold corresponding to the facial feature is not stored.

In an embodiment, acquiring and storing the photograph on the display interface may include: determining a type of the photograph on the display interface;acquiring the photograph on the display interface by triggering a shooting module, if the type of the photograph is an image captured by the shooting module; acquiring the photograph on the display interface by triggering a screenshot operation of a video decoding module, if the type of the photograph is a video played by the video decoding module.

Specifically, with respect to how to automatically acquire the photograph, reference can be made to embodiments hereinafter.

To the end, the above method provided in embodiments of the present disclosure may avoid a subjective evaluation of the user for obtaining a photograph with a higher appearance value from photographs shot at different shooting angles, and avoid a change of shooting angle due to a manual trigger of a shutter button and thus avoid missing a scene where a high appearance value may be obtained, thereby leaving more exciting moments for the user.

The present disclosure will be explained by specific embodiments that follow.

FIG. 2A is a flow chart showing determining whether to trigger an appearance value calculation according to some embodiments, and FIG. 2B is a flow chart showing determining whether to trigger an appearance value calculation according to some embodiments. As shown in FIG. 2A, the following steps are included.

In step S201, it is determined whether an appearance value calculating period is reached according to a preset calculating frequency.

In an embodiment, the preset calculating frequency may be lower than an image capturing frequency of a camera of an electronic device. For example, if the camera captures 20 images per second, the preset calculating frequency may be set as calculating 10 facial appearance values per second. It will be appreciated to those skilled in the art that, number values of 20 or 10 in the present disclosure is exemplary and explanatory only, and shall not be construed to limit the technical solution of the present disclosure.

In step S202, it is determined to trigger the appearance value calculation if the appearance value calculating period is reached.

As the camera of the electronic device captures images in real time, the photograph on the current display interface of the electronic device will change with a movement or angle change of the electronic device. If the appearance value calculating period is reached, it is determined to trigger the appearance value calculation, which may ensure updating the facial appearance value of the photograph on the current display interface in time.

As shown in FIG. 2B, the following steps are included.

In step S211, it is determined whether the photograph on the current display interface changes.

In an embodiment, whether the photograph on the current display interface changes may be determined by detecting whether a reference feature of the photograph on the current display interface changes, in which the reference feature may be, for example, a light intensity value, the facial feature, or a shooting angle of the face of the same user.

In step S212, it is determined to trigger the appearance value calculation, if it is determined that the photograph on the current display interface changes.

As an example, if a change of the light intensity value exceeds a threshold, it indicates that illumination in environment where the electronic device is changes. In this case, the facial appearance value will change, and thus it is required to trigger the appearance value calculation, so as to ensure real-time of the facial appearance value. As another example, the electronic device determines whether there is a need to retrigger the appearance value calculation by detecting a matching degree between image contents of the image currently detected by the camera and a last image, thus avoiding unnecessary triggering of the appearance value calculation, and reducing calculation complexity of the electronic device.

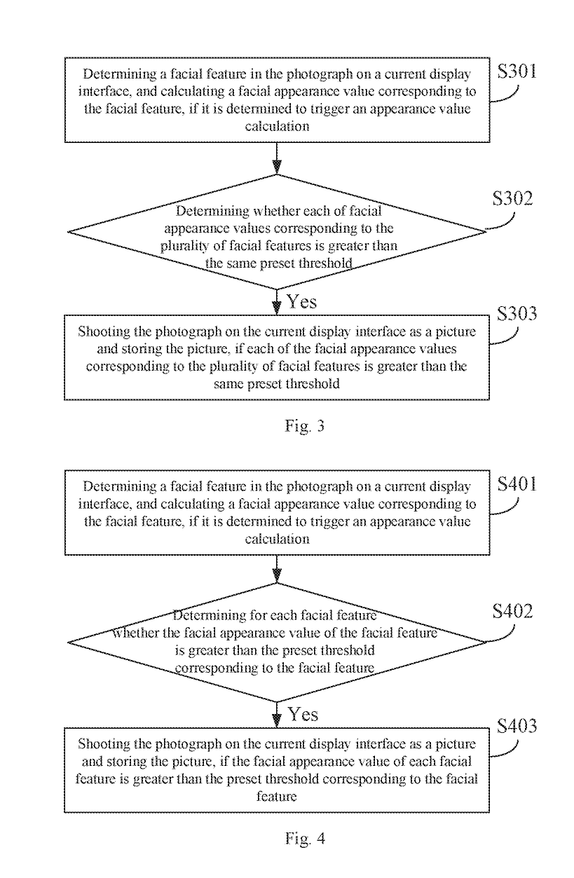

FIG. 3 is a flow chart showing a method for automatically capturing a photograph according to some embodiments. In this embodiment, with above method provided by embodiments of the present disclosure, an exemplary description is made in combination with FIG. 1C by taking such a case as an example, in which there are a plurality of facial features in the photograph on the current display interface and the plurality of facial features correspond to a same preset threshold. As shown in FIG. 3, the following steps are included.

In step S301, a facial feature in the photograph on a current display interface is determined and a facial appearance value corresponding to the facial feature is calculated, if it is determined to trigger an appearance value calculation.

In step S302, it is determined whether each of facial appearance values corresponding to the plurality of facial features is greater than the same preset threshold.

In step S303, the photograph on the current display interface is shot and stored as a picture, if each of the facial appearance values corresponding to the plurality of facial features is greater than the same preset threshold.

As shown in FIG. 1C, facial features of both users C and D are included in the photograph on the current display interface of the electronic device 10. In such a case, a facial appearance value corresponding to the facial feature of the user C and a facial appearance value corresponding to the facial feature of the user D are determined, respectively. If both the facial appearance value of the user C and the facial appearance value of the user D are greater than the same preset threshold, it indicates that the appearance value of each person in the photograph on the current display interface reaches a good level. For example, facial appearance values of both users C and D are above 7.5, and in this case, the photograph on the current display interface may be shot and stored as a picture.

In this embodiment, when each of facial appearance values corresponding to the plurality of facial features is greater than the same preset threshold, the photograph on the current display interface is shot and stored as a picture, which may ensure a higher facial appearance value is achieved for each face in the photograph on the display interface, and avoid the user to store the photograph with higher facial appearance values by manual screenshot or manually triggering a shutter button, thus leaving more exciting moments for the user, and improving user experience.

FIG. 4 is a flow chart showing a method for automatically capturing a photograph according to some embodiments. In this embodiment, with above method provided by embodiments of the present disclosure, an exemplary description is made in combination with FIG. 1C by taking such a case as an example, in which there are a plurality of facial features in the photograph on the current display interface and each of the plurality of facial features corresponds to a respective preset threshold. As shown in FIG. 4, the following steps are included.

In step S401, a facial feature in the photograph on a current display interface is determined and a facial appearance value corresponding to the facial feature is calculated, if it is determined to trigger an appearance value calculation.

In step S402, it is determined for each facial feature whether the facial appearance value of the facial feature is greater than the preset threshold corresponding to the facial feature.

In step S403, the photograph on the current display interface is shot and stored as a picture, if the facial appearance value of each facial feature is greater than the preset threshold corresponding to the facial feature.

As shown in FIG. 1C, facial features of both users C and D are included in the photograph on the current display interface of the electronic device 10. In such a case, a facial appearance value corresponding to the facial feature of the user C and a facial appearance value corresponding to the facial feature of the user D may be determined, respectively. A first preset threshold corresponding to user C is needed to be determined for the user C and a second preset threshold corresponding to user D is needed to be determined for the user D. If the facial appearance value of the user C is greater than the first preset threshold, and the facial appearance value of the user D is greater than the second preset threshold, it indicates that the appearance score of each person in the photograph on the current display interface reaches a good level, for example, appearances of both users C and D are in their corresponding good states, respectively.

In this embodiment, as different users have different appearance values, different preset thresholds are set for the plurality of facial features. If each of the facial appearance values of the plurality of users reaches a respective one of corresponding preset thresholds, the photograph on the current display interface is shot and stored as a picture, which may ensure that each user has an optimum appearance state and the most exciting moment is left for each user, thus improving user experience.

FIG. 5 is a flow chart showing how to determine a preset threshold according to some embodiments. In an embodiment, if it is determined to activate an mode for determining a facial appearance threshold, it is determined to trigger the preset threshold corresponding to the facial feature. In another embodiment, if it is determined to activate a camera to start capturing a photograph, it is determined to trigger the preset threshold corresponding to the facial feature. In yet another embodiment, it is searched whether the preset threshold corresponding to the facial feature is stored after a facial appearance value of the facial feature is calculated, and if it is determined that the preset threshold corresponding to the facial feature is not stored, it is determined to trigger the preset threshold corresponding to the facial feature. Thus, a procedure of this embodiment may be executed. As shown in FIG. 5, the following steps are included.

In step S501, a first preset number of facial appearance values of a user corresponding to the facial feature at different angles are determined.

In step S502, a second preset number of facial appearance values are determined from the first preset number of facial appearance values, in which the second preset number of facial appearance values are top ranked.

In step S503, the preset threshold is determined according to the second preset number of facial appearance values.

As an example, if there is a need to shoot photographs for user A, a statistics is needed to be performed on a first preset number of facial appearance values of user A at different angles. For example, user A is shot at four different angles with 20 photographs for each angle, in particular, 20 photographs with the face of the user turning 30 degrees to the left side, 20 photographs with the face of the user turning 30 degrees to the right side, 20 photographs with raising the user's head by 20 degrees and 20 photographs with lowering the user's head by 20 degrees. That is, a total of 80 photographs are shot for user A, which correspond to 80 (example of the first preset number of the present disclosure) facial appearance values, from which first 10 (example of the second preset number of the present disclosure) facial appearance values are selected based on an order of the appearance values from top to low, and an average value of the first 10 facial appearance values is used as a preset threshold of user A. When photograph-shooting or screenshot is to be performed for user A according to embodiments of the present disclosure, the photograph-shooting or screenshot is automatically triggered if the facial appearance value of user A is calculated to be greater than the preset threshold.

In this embodiment, by performing a statistics on the facial appearance values of the user corresponding to the facial feature at different angles to acquire the preset threshold corresponding to the user, it is possible to ensure that different users correspond to different preset thresholds, and thus ensure that photograph-shooting or screenshot is triggered by different appearance values for different users, thereby ensuring that photograph-shooting or screenshot may be triggered with each user reaching an optimum appearance value thereof.

FIG. 6 is a flow chart showing a method for automatically capturing a photograph according to some embodiments. This embodiment describes how to acquire the photograph on the current display as an example. As shown in FIG. 6, the following steps are included.

In step S601, a facial feature in the photograph on a current display interface is determined and a facial appearance value corresponding to the facial feature is calculated, if it is determined to trigger an appearance value calculation.

In step S602, it is determined whether the facial appearance value is greater than a preset threshold corresponding to the facial feature. If the facial appearance value is greater than the preset threshold, step S603 is executed. If the facial appearance value is lower than or equal to the preset threshold, step S601 is re-executed.

With respect to the description related to step S601 and step S602, reference may be made to the above description related to FIG. 1, which will not be elaborated here.

In step S603, if the facial appearance value is greater than the preset threshold, a type of the photograph on the display interface is determined. If the type of the photograph is an image captured by the shooting module, step S604 is executed, and if the type of the photograph is a video played by the video decoding module, step S605 is executed.

In step S604, if the type of the photograph is an image captured by the shooting module, the photograph on the display interface is acquired by triggering a shooting module.

In step S605, if the type of the photograph is a video played by the video decoding module, the photograph on the display interface is acquired by triggering a screenshot operation of the video decoding module.

In an example scene, as shown in FIG. 1B, with respect to an image captured by camera 12, if it is determined by above related embodiments that a facial appearance value in the image is greater than a preset threshold, a photograph on a display interface is acquired by triggering the camera 12, which enables a user to acquire the photograph on the display interface without triggering a shutter button 13.

In another example scene, as shown in FIG. 1C, with respect to a video played by a video decoding module (also referred to video player application), if it is determined by above related embodiments that a facial appearance value is greater than a preset threshold, the photograph on the display interface is acquired by a screenshot operation of the video decoding module, and thus an optimum moment of the user in the video may be captured, which avoids the user from missing an optimum facial state in the video due to a manual screenshot after a subjective judgment by human eyes.

In this embodiment, by determining a type of the photograph on the display interface, acquiring the photograph on the display interface by triggering a shooting module if the type of the photograph is an image captured by the shooting module or acquiring the photograph on the display interface by triggering a screenshot operation of a video decoding module if the type of the photograph is a video played by the video decoding module, it is possible to ensure that the electronic device automatically keep a photograph with a higher appearance value or perform a screenshot operation in a beauty mode, which is convenient to leave a wonderful moment for the user.

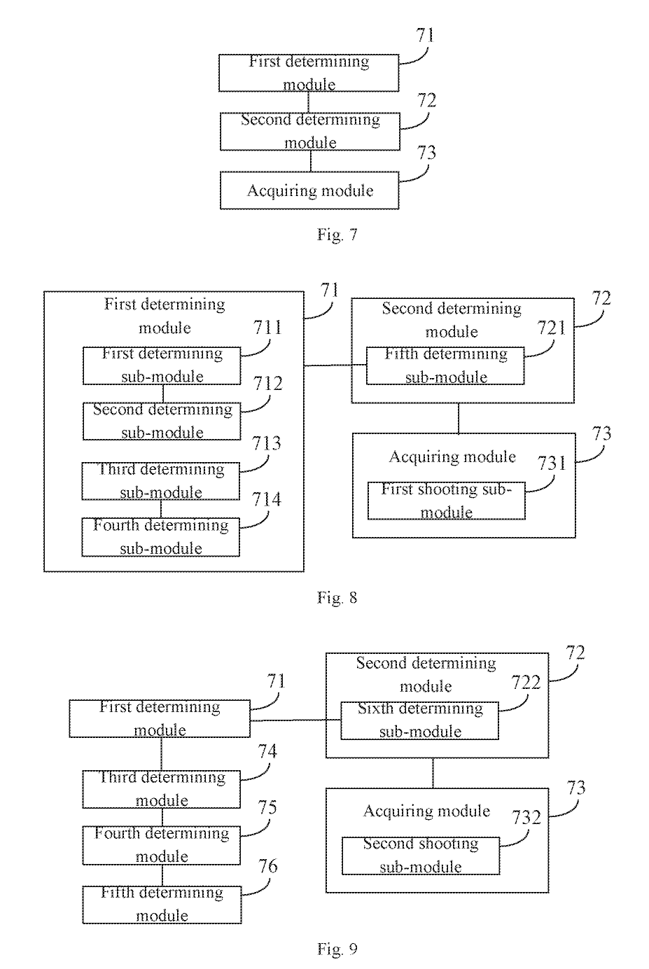

FIG. 7 is a block diagram showing a device for automatically capturing a photograph according to an example embodiment. As shown in FIG. 7, the device for automatically capturing a photograph include: a first determining module 71, configured to determine a facial feature in the photograph on a current display interface and calculate a facial appearance value corresponding to the facial feature, if it is determined to trigger an appearance value calculation; a second determining module 72, configured to determine whether the facial appearance value determined by the first determining module 71 is greater than a preset threshold corresponding to the facial feature; and an acquiring module 73, configured to acquire and store the photograph on the display interface, if it is determined by the second determining module 72 that the facial appearance value is greater than the preset threshold.

FIG. 8 is a block diagram showing another device for automatically capturing a photograph according to an example embodiment. As shown in FIG. 8, on the basis of above embodiment shown in FIG. 7, in an embodiment, the first determining module 71 may include:a first determining sub-module 711, configured to determine whether an appearance value calculating period is reached according to a preset calculating frequency; a second determining sub-module 712, configured to determine to trigger the appearance value calculation if it is determined by the first determining sub-module 711 that the appearance value calculating period is reached; or a third determining sub-module 713, configured to determine whether the photograph on the current display interface changes; a fourth determining sub-module 714, configured to determine to trigger the appearance value calculation if it is determined by the third determining sub-module 713 that the photograph on the current display interface changes.

In an embodiment, if there are a plurality of facial features in the photograph on the current display interface and the plurality of facial features correspond to a same preset threshold, the second determining module 72 may include: a fifth determining sub-module 721, configured to determine whether each of facial appearance values corresponding to the plurality of facial features is greater than the same preset threshold; the acquiring module 73 may include: a first shooting sub-module 731, configured to shoot the photograph on the current display interface as a picture and storing the picture, if it is determined by the fifth determining sub-module 721 that each of the facial appearance values corresponding to the plurality of facial features is greater than the same preset threshold.

FIG. 9 is a block diagram showing further another device for automatically capturing a photograph according to an example embodiment. As shown in FIG. 9, on the basis of above embodiment shown in FIG. 7 or FIG. 8, in an embodiment, if there are a plurality of facial features in the photograph on the current display interface and each of the plurality of facial features corresponds to a respective preset threshold, the second determining module 72 may include: a sixth determining sub-module 722, configured to determine for each facial feature whether the facial appearance value of the facial feature is greater than the preset threshold corresponding to the facial feature; the acquiring module 73 may include: a second shooting sub-module 732, configured to shoot the photograph on the current display interface as a picture and store the picture, if it is determined by the sixth determining sub-module 722 that the facial appearance value of each facial feature is greater than the preset threshold corresponding to the facial feature.

In an embodiment, the device further include: a third determining module 74, configured to determine a first preset number of facial appearance values of a user corresponding to the facial feature determined by the first determining module 71 at different angles; a fourth determining module 75, configured to determine a second preset number of facial appearance values from the first preset number of facial appearance values determined by the third determining module 74, in which the second preset number of facial appearance values are top ranked; a fifth determining module 76, configured to determine the preset threshold according to the second preset number of facial appearance values determined by the fourth determining module 75.

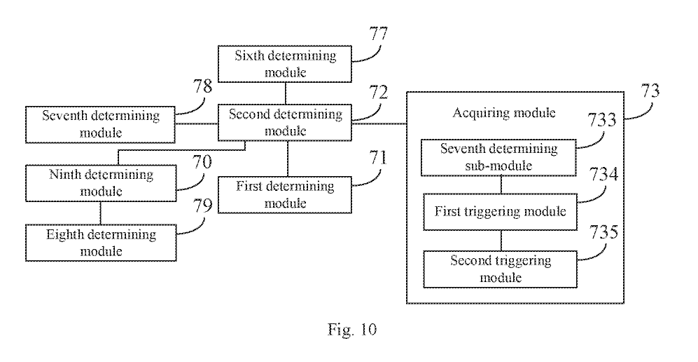

FIG. 10 is a block diagram showing yet another device for automatically capturing a photograph according to an example embodiment. As shown in FIG. 10, on the basis of any embodiment shown in FIG. 7 to FIG. 9, in an embodiment, the device may further include: a sixth determining module 77, configured to determine to trigger the preset threshold corresponding to the facial feature if it is determined to activate an mode for determining a facial appearance threshold, such that the second determining module 72 can determine whether the facial appearance value is greater than the preset threshold corresponding to the facial feature; or a seventh determining module 78, configured to determine to trigger the preset threshold corresponding to the facial feature if it is determined to activate a camera to start capturing a photograph, such that the second determining module 72 can determine whether the facial appearance value is greater than the preset threshold corresponding to the facial feature; or an eighth determining module 79, configured to search whether the preset threshold corresponding to the facial feature is stored after a facial appearance value of the facial feature is calculated; a ninth determining module 70, configured to determine to trigger the preset threshold corresponding to the facial feature if it is determined by the eighth determining module 79 that the preset threshold corresponding to the facial feature is not stored, such that the second determining module 72 can determine whether the facial appearance value is greater than a preset threshold corresponding to the facial feature.

In an embodiment, the acquiring module 73 may include: a seventh determining sub-module 733, configured to determine a type of the photograph on the display interface; a first triggering sub-module 734, configured to trigger a shooting module for acquiring the photograph on the display interface, if it is determined by the seventh determining sub-module 733 that the type of the photograph is an image captured by the shooting module; and a second triggering sub-module 735, configured to trigger a screenshot operation of the video decoding module for acquiring the photograph on the display interface, if it is determined by the seventh determining sub-module 733 that the type of the photograph is a video played by the video decoding module.

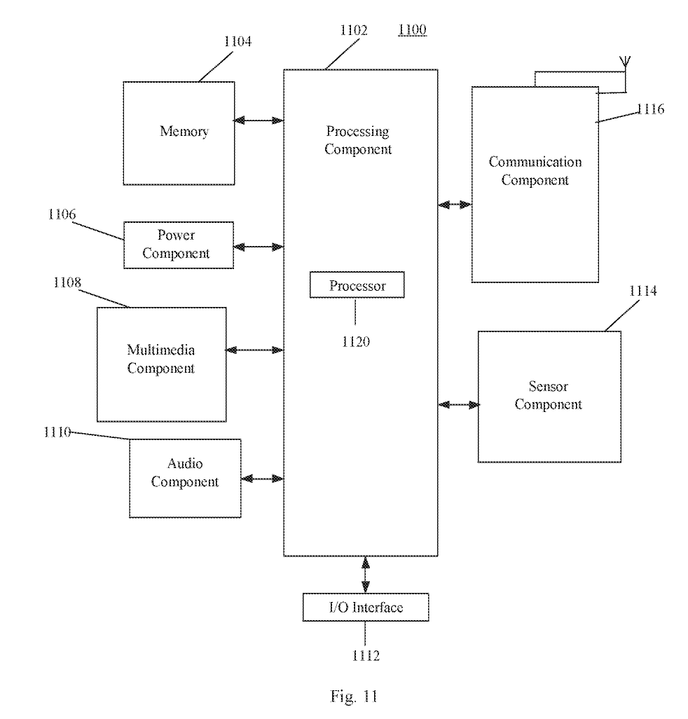

FIG. 11 is a block diagram showing a device suitable for automatically capturing a photograph according to an example embodiment. For example, the device 1100 may be a mobile phone, a computer, a vidicon, a camera, a digital broadcast terminal, a messaging device, a gaming console, a tablet, a medical device, exercise equipment, a personal digital assistant, and the like.

Referring to FIG. 11, the device 1100 may include one or more of the following components: a processing component 1102, a memory 1104, a power component 1106, a multimedia component 1108, an audio component 1110, an input/output (I/O) interface 1112, a sensor component 1114, and a communication component 1116.

The processing component 1102 typically controls overall operations of the device 1100, such as the operations associated with display, telephone calls, data communications, camera operations, and recording operations. The processing component 1102 may include one or more processors 1120 to execute instructions to perform all or part of the steps in the above described methods. Moreover, the processing component 1102 may include one or more modules which facilitate the interaction between the processing component 1102 and other components. For instance, the processing component 1102 may include a multimedia module to facilitate the interaction between the multimedia component 1108 and the processing component 1102.

The memory 1104 is configured to store various types of data to support the operation of the device 1100. Examples of such data include instructions for any applications or methods operated on the device 1100, contact data, phonebook data, messages, pictures, video, etc. The memory 1104 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1106 provides power to various components of the device 1100. The power component 1106 may include a power management system, one or more power sources, and any other components associated with the generation, management, and distribution of power in the device 1100.

The multimedia component 1108 includes a screen providing an output interface between the device 1100 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1108 includes a front camera and/or a rear camera. The front camera and/or the rear camera may receive an external multimedia datum while the device 1100 is in an operation mode, such as a photographing mode or a video mode. Each of the front camera and the rear camera may be a fixed optical lens system or have focus and optical zoom capability.

The audio component 1110 is configured to output and/or input audio signals. For example, the audio component 1110 includes a microphone (MIC) configured to receive an external audio signal when the device 1100 is in an operation mode, such as a call mode, a recording mode, and a voice recognition mode. The received audio signal may be further stored in the memory 1104 or transmitted via the communication component 1116. In some embodiments, the audio component 1110 further includes a speaker to output audio signals.

The I/O interface 1112 provides an interface between the processing component 1102 and peripheral interface modules, such as a keyboard, a click wheel, buttons, and the like. The buttons may include, but are not limited to, a home button, a volume button, a starting button, and a locking button.

The sensor component 1114 includes one or more sensors to provide status assessments of various aspects of the device 1100. For instance, the sensor component 1114 may detect an open/closed status of the device 1100, relative positioning of components, e.g., the display and the keypad, of the device 1100, a change in position of the device 1100 or a component of the device 1100, a presence or absence of user contact with the device 1100, an orientation or an acceleration/deceleration of the device 1100, and a change in temperature of the device 1100. The sensor component 1114 may include a proximity sensor configured to detect the presence of nearby objects without any physical contact. The sensor component 1114 may also include a light sensor, such as a CMOS or CCD image sensor, for use in imaging applications. In some embodiments, the sensor component 1114 may also include an accelerometer sensor, a gyroscope sensor, a magnetic sensor, a pressure sensor, or a temperature sensor.

The communication component 1116 is configured to facilitate communication, wired or wirelessly, between the device 1100 and other devices. The device 1100 can access a wireless network based on a communication standard, such as WiFi, 2G, or 3G, or a combination thereof In one example embodiment, the communication component 1116 receives a broadcast signal or broadcast associated information from an external broadcast management system via a broadcast channel. In one example embodiment, the communication component 1116 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In example embodiments, the device 1100 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In example embodiments, there is also provided a non-transitory computer-readable storage medium including instructions, such as included in the memory 1104, executable by the processor 1120 in the device 1100, for performing the above-described methods. For example, the non-transitory computer-readable storage medium may be a ROM, a RAM, a CD-ROM, a magnetic tape, a floppy disc, an optical data storage device, and the like.

Other embodiments will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present disclosure is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for automatically capturing a photograph, the method comprising:
determining a facial feature in the photograph on a current display interface;
calculating a facial appearance value corresponding to the facial feature, if it is determined to trigger an appearance value calculation;
determining whether the facial appearance value is greater than a preset threshold corresponding to the facial feature; and
acquiring and storing the photograph on the display interface, if the facial appearance value is greater than the preset threshold.

2. The method according to claim 1, wherein determining to trigger an appearance value calculation comprises:
determining whether an appearance value calculating period is reached according to a preset calculating frequency; and
determining to trigger the appearance value calculation if the appearance value calculating period is reached.

3. The method according to claim 1, wherein determining to trigger an appearance value calculation comprises:
determining whether the photograph on the current display interface changes; and
determining to trigger the appearance value calculation if it is determined that the photograph on the current display interface changes.

4. The method according to claim 1, wherein if there are a plurality of facial features in the photograph on the current display interface and the plurality of facial features correspond to a same preset threshold,
determining whether the facial appearance value is greater than a preset threshold corresponding to the facial feature comprises:
determining whether each of facial appearance values corresponding to the plurality of facial features is greater than the same preset threshold;
storing a pre-shot picture if the facial appearance value is greater than the preset threshold comprises:
shooting the photograph on the current display interface as a picture and storing the picture, if each of the facial appearance values corresponding to the plurality of facial features is greater than the same preset threshold.

5. The method according to claim 1, wherein if there are a plurality of facial features in the photograph on the current display interface and each of the plurality of facial features corresponds to a respective preset threshold,
determining whether the facial appearance value is greater than a preset threshold corresponding to the facial feature comprises:
determining for each facial feature whether the facial appearance value of the facial feature is greater than the preset threshold corresponding to the facial feature;
storing a pre-shot picture if the facial appearance value is greater than the preset threshold comprises:
shooting the photograph on the current display interface as a picture and storing the picture, if the facial appearance value of each facial feature is greater than the preset threshold corresponding to the facial feature.

6. The method according to claim 1, further comprising:
determining a first preset number of facial appearance values of a user corresponding to the facial feature at different angles;
determining a second preset number of facial appearance values from the first preset number of facial appearance values, wherein the second preset number of facial appearance values are top ranked;
determining the preset threshold according to the second preset number of facial appearance values.

7. The method according to claim 6, further comprising:
determining to trigger the preset threshold corresponding to the facial feature, if it is determined to activate an mode for determining a facial appearance threshold.

8. The method according to claim 6, further comprising:
determining to trigger the preset threshold corresponding to the facial feature, if it is determined to activate a camera to start capturing a photograph.

9. The method according to claim 6, further comprising:
searching whether the preset threshold corresponding to the facial feature is stored after a facial appearance value of the facial feature is calculated; and
determining to trigger the preset threshold corresponding to the facial feature, if it is determined that the preset threshold corresponding to the facial feature is not stored.

10. The method according to claim 1, wherein acquiring and storing the photograph on the display interface comprises:
determining a type of the photograph on the display interface;
acquiring the photograph on the display interface by triggering a shooting module, if the type of the photograph is an image captured by the shooting module; and
acquiring the photograph on the display interface by triggering a screenshot operation of a video decoding module, if the type of the photograph is a video played by the video decoding module.

11. An electronic device, comprising:
a processor; and
a memory, configured to store an instruction executable by the processor;
wherein the processor is configured to:
determine a facial feature in the photograph on a current display interface;
calculate a facial appearance value corresponding to the facial feature, if it is determined to trigger an appearance value calculation;
determine whether the facial appearance value is greater than a preset threshold corresponding to the facial feature; and
acquire and store the photograph on the display interface, if the facial appearance value is greater than the preset threshold.

12. The electronic device according to claim 11, wherein the processor configured to determine to trigger an appearance value calculation is further configured to:
determine whether an appearance value calculating period is reached according to a preset calculating frequency; and
determine to trigger the appearance value calculation if the appearance value calculating period is reached.

13. The electronic device according to claim 11, wherein the processor configured to determine to trigger an appearance value calculation is further configured to:
determine whether the photograph on the current display interface changes; and
determine to trigger the appearance value calculation if it is determined that the photograph on the current display interface changes.

14. The electronic device according to claim 11, wherein if there are a plurality of facial features in the photograph on the current display interface and the plurality of facial features correspond to a same preset threshold, the processor configured to determine whether the facial appearance value is greater than a preset threshold corresponding to the facial feature is further configured to:
determine whether each of facial appearance values corresponding to the plurality of facial features is greater than the same preset threshold; and
wherein the processor configured to store a pre-shot picture if the facial appearance value is greater than the preset threshold is further configured to:
shoot the photograph on the current display interface as a picture and store the picture, if each of the facial appearance values corresponding to the plurality of facial features is greater than the same preset threshold.

15. The electronic device according to claim 11, wherein if there are a plurality of facial features in the photograph on the current display interface and each of the plurality of facial features corresponds to a respective preset threshold, the processor configured to determine whether the facial appearance value is greater than a preset threshold corresponding to the facial feature is further configured to:
determine for each facial feature whether the facial appearance value of the facial feature is greater than the preset threshold corresponding to the facial feature; and
wherein the processor configured to store a pre-shot picture if the facial appearance value is greater than the preset threshold is further configured to:
shoot the photograph on the current display interface as a picture and store the picture, if the facial appearance value of each facial feature is greater than the preset threshold corresponding to the facial feature.

16. The electronic device according to claim 11, wherein the processor is further configured to:
determine a first preset number of facial appearance values of a user corresponding to the facial feature at different angles;
determine a second preset number of facial appearance values from the first preset number of facial appearance values, wherein the second preset number of facial appearance values are top ranked; and
determine the preset threshold according to the second preset number of facial appearance values.

17. The electronic device according to claim 16, wherein the processor is further configured to:
determine to trigger the preset threshold corresponding to the facial feature, if it is determined to activate an mode for determining a facial appearance threshold.

18. The electronic device according to claim 16, wherein the processor is further configured to:
determine to trigger the preset threshold corresponding to the facial feature, if it is determined to activate a camera to start capturing a photograph.

19. The electronic device according to claim 16, wherein the processor is further configured to:
search whether the preset threshold corresponding to the facial feature is stored after a facial appearance value of the facial feature is calculated; and
determine to trigger the preset threshold corresponding to the facial feature, if it is determined that the preset threshold corresponding to the facial feature is not stored.

20. The electronic device according to claim 11, wherein the processor configured to acquire and store the photograph on the display interface is further configured to:
determine a type of the photograph on the display interface;
acquire the photograph on the display interface by triggering a shooting module, if the type of the photograph is an image captured by the shooting module; and
acquire the photograph on the display interface by triggering a screenshot operation of a video decoding module, if the type of the photograph is a video played by the video decoding module.

21. A non-transitory computer-readable storage medium having stored therein instructions that, when executed by a processor of an electronic device, cause the electronic device to perform a method for automatically capturing a photograph, the method comprising:
determining a facial feature in the photograph on a current display interface;
calculating a facial appearance value corresponding to the facial feature, if it is determined to trigger an appearance value calculation;
determining whether the facial appearance value is greater than a preset threshold corresponding to the facial feature; and
acquiring and storing the photograph on the display interface, if the facial appearance value is greater than the preset threshold.
